(19) United States
(12) Patent Application Publication
(10) Pub. No.: US 2003/0003905 A1
(43) Pub. Date: Jan. 2, 2003

(54) System and method for providing signal quality feedback in a wireless network

(76) Inventor: William M. Shvodian, McLean, VA (US)

Correspondence Address: Brian C. Altmiller, XtremeSpectrum, Inc., Suite 700, 8133 Leesburg Pike, Vienna, VA, 22182, US

(21) Appl. No.: 10/175,030

(22) Filed: Jun. 20, 2002

Related U.S. Application Data
(60) Provisional application No. 60/299,197, filed on Jun. 20, 2001.

(51) Int. Cl. H04Q 7/20

(52) U.S. Cl. 455/423; 455/522; 455/67.1

(57) ABSTRACT

A method is provided for giving signal quality feedback in a wireless network. First, a transmitting device sends a data packet to a receiving device in a data signal. This data signal is sent at a first transmission power and a first data transmission rate. The receiving device receives the data packet in the data signal and determines a signal quality metric for the data signal. The receiving device then sends an acknowledgement frame to the transmitting device in an acknowledgement signal. The acknowledgement frame includes one or more feedback bits, which indicates a relative signal quality of the data signal. The transmitting device receives the acknowledgement frame in the acknowledgement signal at the transmitting device, and adjusts the first transmission power and the first data transmission rate to a second transmission power and a second data transmission rate, respectively, based on the one or more feedback bits.

### CROSS-REFERENCE TO RELATED PATENT DOCUMENTS

The present document claims the benefit of the earlier filing date of co-pending U.S. provisional patent application Serial No. 60/299,197, filed Jun. 20, 2001, entitled “IEEE 802.15.3: A PROPOSAL TO MODIFY THE FRAME TYPES AND COMMANDS,” the contents of which are incorporated by reference in its entirety.

### BACKGROUND OF THE INVENTION

The present invention relates to wireless personal area networks and wireless local area networks. More particularly, the present invention relates to systems, methods, devices, and computer program products for controlling transmitted power and transmission rate in a wireless personal area network or wireless local area network environment.

The International Standards Organization's (ISO) Open Systems Interconnection (OSI) standard provides a seven-layered hierarchy between an end user and a physical device through which different systems can communicate. Each layer is responsible for different tasks, and the OSI standard specifies the interaction between layers, as well as between devices complying with the standard.

FIG. 1 shows the hierarchy of the seven-layered OSI standard. As seen in FIG. 1, the OSI standard 100 includes a physical layer 110, a data link layer 120, a network layer 130, a transport layer 140, a session layer 150, a presentation layer 160, and an application layer 170.

The physical (PHY) layer 110 conveys the bit stream through the network at the electrical, mechanical, functional, and procedural level. It provides the hardware means of sending and receiving data on a carrier. The data link layer 120 describes the representation of bits on the physical medium and the format of messages on the medium, sending blocks of data (such as frames) with proper synchronization. The networking layer 130 handles the routing and forwarding of the data to proper destinations, maintaining and terminating connections. The transport layer 140 manages the end-to-end control and error checking to ensure complete data transfer. The session layer 150 sets up, coordinates, and terminates conversations, exchanges, and dialogs between the applications at each end. The presentation layer 160 converts incoming and outgoing data from one presentation format to another. The application layer 170 is where communication partners are identified, quality of service is identified, user authentication and privacy are considered, and any constraints on data syntax are identified.

The IEEE 802 Committee has developed a three-layer architecture for local networks that roughly corresponds to the physical layer 110 and the data link layer 120 of the OSI standard 100. FIG. 2 shows the IEEE 802 standard 200.

As shown in FIG. 2, the IEEE 802 standard 200 includes a physical (PHY) layer 210, a media access control (MAC) layer 220, and a logical link control (LLC) layer 225. The PHY layer 210 operates essentially as the PHY Layer 110 in the OSI standard 100. The MAC and LLC layers 220 and 225 share the functions of the data link layer 120 in the OSI standard 100. The LLC layer 225 places data into frames that can be communicated at the PHY layer 210; and the MAC layer 220 manages communication over the data link, sending data frames and receiving acknowledgement (ACK) frames. Together the MAC and LLC layers 220 and 225 are responsible for error checking as well as retransmission of frames that are not received and acknowledged.

FIG. 3 is a block diagram of a wireless network 300 that could use the IEEE 802.15 standard 200. In a preferred embodiment the network 300 is a wireless personal area network (WPAN), or piconet. However, it should be understood that the present invention also applies to other settings where bandwidth is to be shared among several users, such as, for example, wireless local area networks (WLAN), or any other appropriate wireless network.

When the term piconet is used, it refers to a network of devices connected in an ad hoc fashion, having one device act as a controller (i.e., it functions as a master) while the other devices follow the instructions of the controller (i.e., they function as slaves). The controller can be a designated device, or simply one of the devices chosen to function as a controller. One primary difference between devices and the controller is that the controller must be able to communicate with all of the devices in the network, while the various devices need not be able to communicate with all of the other devices.

As shown in FIG. 3, the network 300 includes a controller 310 and a plurality of devices 320. The controller 310 serves to control the operation of the network 300. As noted above, the system of controller 310 and devices 320 may be called a piconet, in which case the controller 310 may be referred to as a piconet controller (PNC). Each of the devices 320 must be connected to the controller 310 via primary wireless links 330, and may also be connected to one or more other devices 320 via secondary wireless links 340. Each device 320 of the network 300 may be a different wireless device, for example, a digital still camera, a digital video camera, a personal data assistant (PDA), a digital music player, or other personal wireless device.

In some embodiments the controller 310 may be the same sort of device as any of the devices 320, except with the additional functionality for controlling the system and the requirement that it communicate with every device 320 in the network 300. In other embodiments the controller may be a separate designated device.

The various devices 320 are confined to a usable physical area 350, which is set based on the extent to which the controller 310 can successfully communicate with each of the devices 320. Any device 320 that is able to communicate with the controller 310 (and vice versa) is within the usable area 350 of the network 300. As noted, however, it is not necessary for every device 320 in the network 300 to communicate with every other device 320.

FIG. 4 is a block diagram of a controller 310 or a device 320 from the network 300 of FIG. 3. As shown in FIG. 4, each controller 310 or device 320 includes a physical (PHY) layer 410, a media access control (MAC) layer 420, a set of upper layers 430, and a management entity 440.

The PHY layer 410 communicates with the rest of the network 300 via a primary or secondary wireless link 330 or 340. It generates and receives data in a transmittable data format and converts it to and from a format usable through the MAC layer 420. The MAC layer 420 serves as an interface between the data formats required by the PHY layer 410 and those required by the upper layers 430. The upper layers 205 include the functionality of the device 320. These upper layers 430 may include TCP/IP, TCP, UDP, RTP, IP, LLC, or the like.

Typically, the controller 310 and the devices 320 in a WPAN share the same bandwidth. Accordingly, the controller 310 coordinates the sharing of that bandwidth. Standards have been developed to establish protocols for sharing bandwidth in a wireless personal area network (WPAN) setting. For example, the IEEE standard 802.15.3 provides a specification for the PHY layer 410 and the MAC layer 420 in such a setting where bandwidth is shared using time division multiple access (TDMA). Using this standard, the MAC layer 420 defines frames and superframes through which the sharing of the bandwidth by the devices 320 is managed by the controller 310 and/or the devices 320.

WPANs (or piconets) are networks that are typically used to share information between personal electronic devices confined to within a house, an office, a floor of a building, etc. Accordingly, many users (or nodes) of WPANs are small battery-operated devices. With such devices, it is advantageous to minimize the size of the device as well as the power consumption, thereby extending battery life. Low power transmissions also have the advantage of minimizing interference with other networks. And high transmission rates minimize channel time usage, which is a limited resource.

Factors that influence power consumption include the transmission power each device 320 uses, and the transmission rate of each device 320. However, there is currently no mechanism in place in the standards, such as the IEEE 802.15.3 standard, to provide signal quality information from a receiver to a transmitter, which feedback would be helpful to enable a user to control its transmitter power or to alter its transmission rate. As a result, there is less opportunity to enhance both power efficiency and optimize data transmission rates.

Devices currently only receive data regarding the success/failure of packet transmission, which doesn't provide sufficient information to adjust the transmit rate and power. For implementations that can allow a high packet error rate (PER), statistics are sufficient. However, when very low PERs must be maintained, the errors will be infrequent enough that statistics will not be meaningful.

### SUMMARY OF THE INVENTION

The inventor of the present invention has recognized that conventional wireless network protocols do not provide adequate feedback for signal quality for data packets transmitted during guaranteed time slots, which prevents the optimization of transmission power and data transmission rate. Accordingly, one object of the present invention is to provide a solution to this problem, as well as other problems and deficiencies associated with wireless network protocols.

In one embodiment of the present invention, a method is provided for giving signal quality feedback in a wireless network. This method includes the steps of: sending a data packet from a transmitting device to a receiving device in a wireless data signal sent over a wireless link at a first transmission power and a first data transmission rate; receiving the data packet in the wireless data signal at a receiving device; determining at the receiving device a signal quality metric for the wireless data signal; sending an acknowledgement frame from the receiving device to the transmitting device in a wireless acknowledgement signal, the acknowledgement frame including one or more feedback bits indicating a relative signal quality of the wireless data signal; receiving the acknowledgement frame in the wireless acknowledgement signal at the transmitting device; and adjusting the first transmission power and the first data transmission rate to a second transmission power and a second data transmission rate, respectively, based on the one or more feedback bits.

The signal quality metric is preferably signal-to-noise ratio, bit error rate, or a received signal strength indication. The acknowledgement frame is preferably an immediate acknowledgement frame.

Preferably one of the values of the one or more feedback bits indicates that the wireless data signal has a signal quality metric that is above an optimal range. When the feedback bits has this value, either the second transmission power is lower than the first transmission power (i.e., the transmitting device lowers the transmission power), or the second data transmission rate is higher than the first data transmission rate (i.e., the transmitting device raises the data transmission rate. Preferably there are two feedback bits, though there may be more or fewer.

A first combination of the two feedback bits preferably indicates that the wireless data signal has a signal quality metric that is above an optimal range; a second combination of the two feedback bits preferably indicates that the wireless data signal has a signal quality metric that is within an optimal range; a third combination of the two feedback bits preferably indicates that the wireless data signal has a signal quality metric that is below an optimal range, and a fourth combination of the two feedback bits preferably indicates that no signal quality information has been provided.

More generically, the one or more feedback bits preferably indicate whether the signal quality metric of the wireless data signal is within an optimal range, above an optimal range, or below an optimal range.

Adjusting the first transmission power and the first data transmission rate to a second transmission power and a second data transmission rate, respectively, can involve having the second transmission power equal the first transmission power and having the second data transmission rate equal the first data transmission rate. In other words, if the data signal is in the optimum range, the transmission power and the data transmission rate need not change at all.

Consistent with the title of this section, the above summary is not intended to be an exhaustive discussion of all the features or embodiments of the present invention. A more complete, although not necessarily exhaustive, description of the features and embodiments of the invention is found in the section entitled “DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings. In these drawings like reference numerals designate identical or corresponding parts throughout the several views.

FIG. 1 is a block diagram of the OSI standard for a computer communication architecture;

FIG. 2 is a block diagram of the IEEE 802 standard for a computer communication architecture;

FIG. 3 is a block diagram of a wireless network;

FIG. 4 is a block diagram of a device or controller in the wireless network of FIG. 3;

FIG. 5 illustrates an exemplary structure of a series of superframes having guaranteed time slots during the contention free period according to one embodiment of the present invention;

FIG. 6 is a block diagram of a subset of the network of FIG. 3, including a transmitting device and a receiving device connected by a secondary wireless link according to a preferred embodiment of the present invention;

FIG. 7 is a flow chart of the transmission of a data packet and an ACK frame according to a preferred embodiment of the present invention; and

FIG. 8 is a flow chart of the transmission of a data packet and an ACK frame according to another preferred embodiment of the present invention

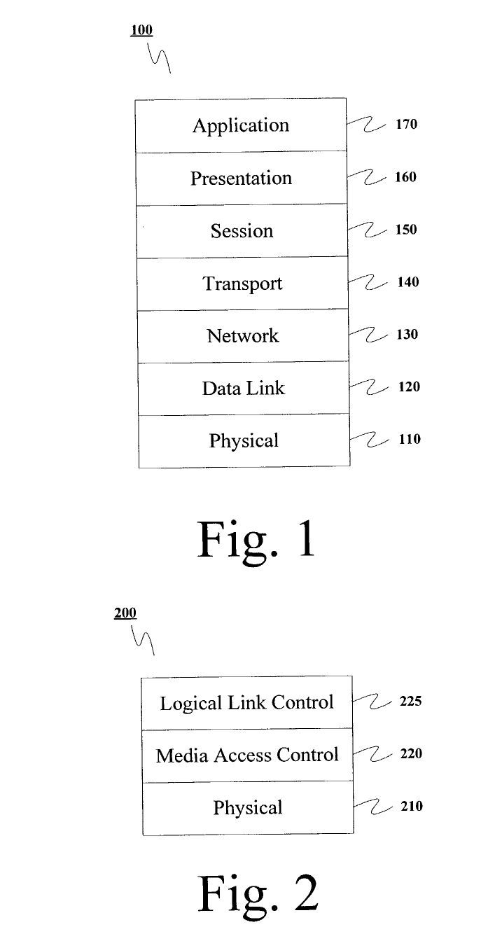

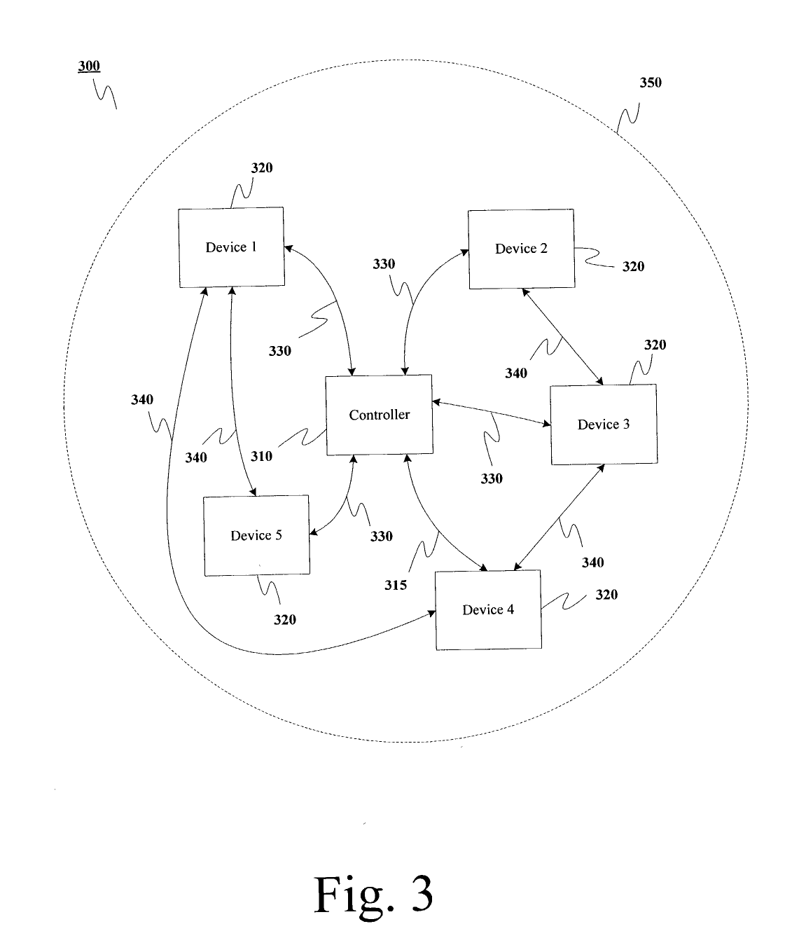

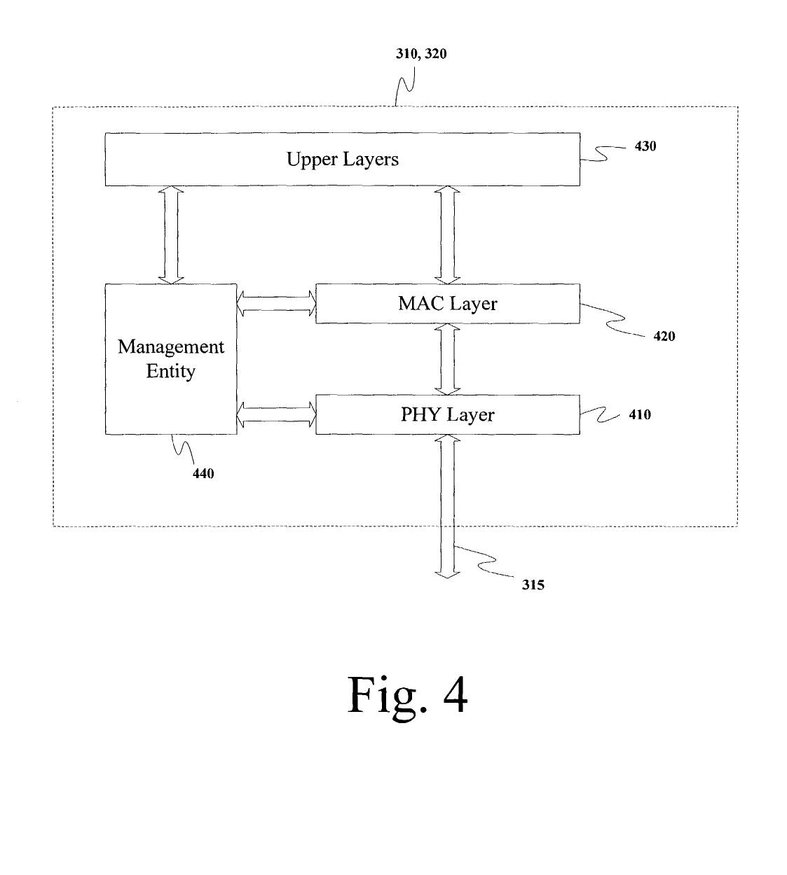

### DETAILED DESCRIPTION OF THE PREFERRED EMBODIMENTS

Preferred embodiments of the present invention will be described below. And while the embodiments described herein will be in the context of a WPAN (or piconet), it should be understood that the present invention also applies to other settings where bandwidth is to be shared among several users, such as, for example, wireless local area networks (WLAN), or any other appropriate wireless network.

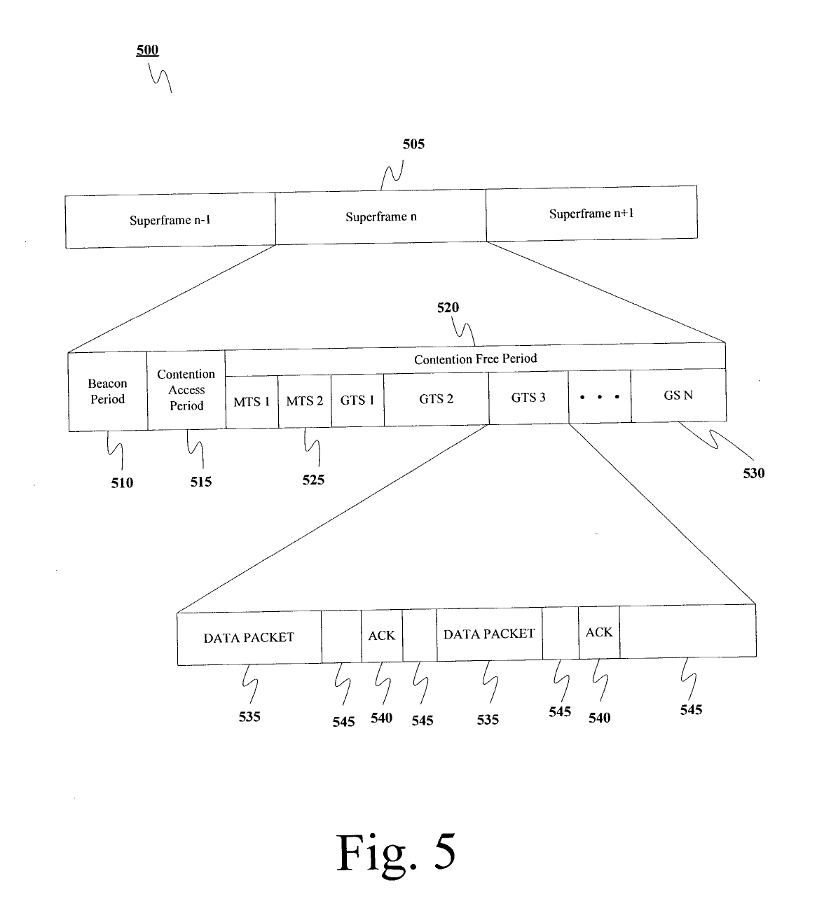

FIG. 5 illustrates a data transmission scheme 500 in which information is transmitted through a network via including a plurality of MAC superframes 505 each including guaranteed time slots (GTSs), according to a preferred embodiment of the present invention. Preferably the superframes 505 are of a set length to allow various devices in the network to coordinate with a network controller or other devices in the network.

As shown in FIG. 5, the data transmission scheme 500 includes transmitting successive superframes 505 in time across the network 300. Each superframe 505 includes a beacon 510, an optional contention access period 515, and a contention free period 520. The contention free period 520 may include one or more management time slots (MTSs) 525 and one or more guaranteed time slots (GTSs) 530.

In the preferred embodiment there are as many guaranteed time slots 530 as there are primary and secondary wireless links 330 and 340. However, this may change in alternate embodiments. There may be greater or fewer guaranteed time slots 530 than there are devices 320. In this case the controller 310 will designate how the devices 320 should use the available guaranteed time slots 530.

The controller 310 uses the beacon 515 to coordinate the scheduling of the individual devices 320 into their respective guaranteed time slots 530. All devices 320 listen to the controller 310 during the beacon period 510. Each device 320 will receive zero or more guaranteed time slots 530, being notified of each start time and duration from the controller 310 during the beacon period 510. Channel time allocation (CTA) fields in the beacon 510 include start times, packet duration, source device ID, and destination device ID. As a result, each device knows when to transmit and when to receive. In all other times the device 320 may cease listening and go into a power conservation mode. The beacon period 510, therefore, is used to coordinate the transmitting and receiving of the devices 320.

The network can pass control and administrative information between the controller 310 and the various devices 320 through the optional contention access period 515, the management time slots 525, or both. The particular implementation will determine what particular option is used: it could include a contention access period 515, one or more management time slots 525, or some combination of both.

Management time slots 525 can be downlink time slots in which information is sent from the controller 310 to the devices 320, or uplink time slots in which information is sent from the devices 320 to the controller 310. In this preferred embodiment two management time slots 525 are used per superframe, one uplink and one downlink, though alternate embodiments could choose different numbers of management time slots and mixtures of uplink and downlink.

If a new device 320 desires to be added to the network 300, it requests entry from the controller 310 either in the optional contention access period 330 or in one of the management time slots 525. If a particular device 320 has no need to coordinate with the controller 310 during the optional contention access period 515 or the management time slots 525, that device 320 may remain silent during the optional contention access period 515 or the management time slots 525. In this case that device 320 need not even listen to the controller 310 during the optional contention access period 515 or the management time slots 525, and may go into a power-conserving mode.

Individual devices then transmit data packets during the contention free period 340. The devices 320 use the guaranteed time slots 530 assigned to them to transmit data packets 535 to other devices (which may include the controller 310 if the controller 310 is also a device 320 within the network 300). Each device 320 may send one or more packets of data 535, and may request an immediate acknowledgement (ACK) frame 540 from the recipient device 320 indicating that the packet was successfully received, or may request a delayed (grouped) acknowledgement. If an immediate ACK frame 540 is requested, the transmitting device 320 should allocate sufficient time in the guaranteed time slot 530 to allow for the ACK frame 540 to arrive.

In this embodiment a guaranteed time slot 530 is shown as having a plurality of data packets 535 and associated ACK frames 540. Generally there is also a delay period 545 between the data packets 535 and ACK frames 540, and between a final acknowledgement 540 and the end of the guaranteed time slot 530.

Since each particular device 320 knows its transmit start time and duration from information received during the beacon period 510, each device 320 can remain silent until it is its turn to transmit. Moreover, a given device 320 need not listen during any guaranteed time slot periods 530 in which it is not assigned to either transmit or receive, and may enter into a power conservation mode. Since the time periods corresponding to each guaranteed time slot 530 have been fully coordinated by the controller 310 during the beacon period 510, individual devices 320 know when not to listen.

The guaranteed time slots 530 shown in this embodiment may be of differing sizes. The starting times and durations of the guaranteed time slots 530 are determined by the controller 310 and sent to the devices 320 during the contention access period 330 or one of the management time slots 525, as implemented.

During each guaranteed time slot 530 the associated device 320 transmits its data packets 535 at a particular power level and data rate. These transmit parameters are chosen primarily to make certain that the data packet 535 is successfully transmitted to a receiving device, but also to maximize the data transmission speed and minimize the power consumption and interference. Ideally the data packet 535 is transmitted at the lowest power possible to guarantee successful transmission and at as high a speed as possible, while ensuring that the data is transmitted successfully in order to minimize channel time usage. In one embodiment, the transmitting device 320 knows that the data packet 535 was transmitted successfully when it receives the ACK frame 540 from the receiving device 320.

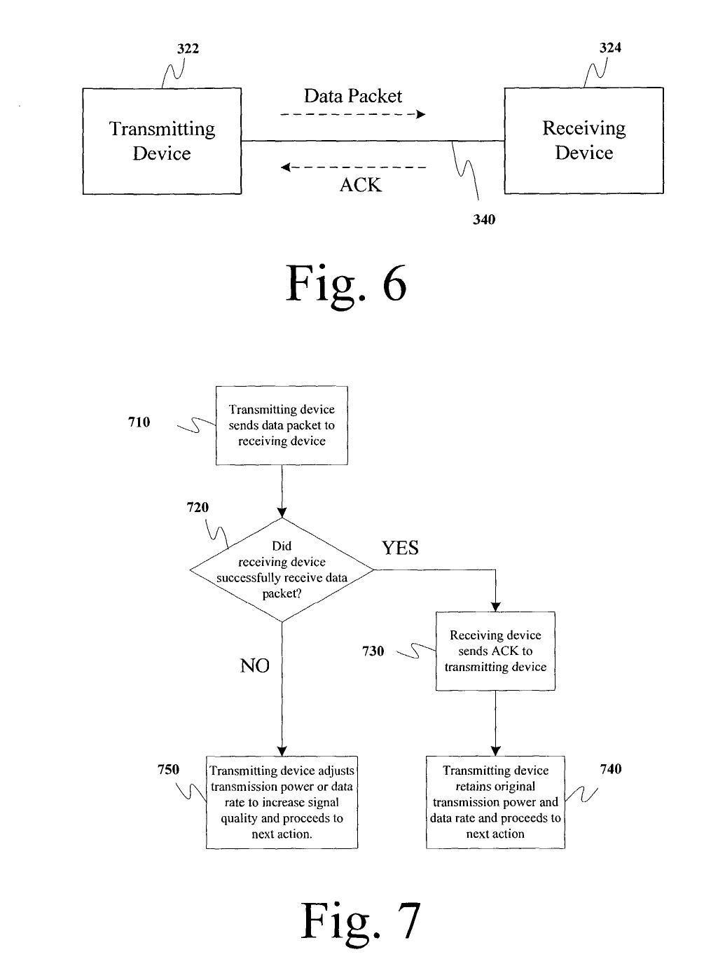

FIG. 6 is a block diagram of a subset of a network 300 including a transmitting device 322 and a receiving device 324 connected by a secondary wireless link 340. Although not shown, both the transmitting device 322 and the receiving device 324 are connected to a controller 310 via primary wireless links 330. In addition, if one of the devices 322, 324 were a controller as well as a device, the primary wireless link 330 between them could be used for this transmission.

As shown in FIG. 6, the transmitting device 322 sends a data packet 535 to the receiving device 324, and if the receiving device 324 successfully receives the data packet 535, then it sends an ACK frame 540 to the transmitting device 324. If the receiving device 324 does not successfully receive the data packet 535, no ACK frame 540 is sent.

FIG. 7 is a flow chart of the transmission of a data packet 535 and an ACK frame 540 according to a preferred embodiment of the present invention. As shown in FIG. 7, the transmitting device 322 begins by transmitting a data packet 535 to the receiving device 324. (Step 710) This transmission is done over a secondary wireless link 340, unless one of the two devices is also the controller, in which case it may be done over a primary wireless link 330.

The receiving device 324 then determines whether it properly received the data packet 535. (Step 720) If the receiving device 324 properly received the data packet 535, it sends an ACK frame 540 to the transmitting device 322. (Step 730) If the receiving device 324 did not properly receive the data packet 535 (i.e., it did not receive the data packet 535 within a set time), no ACK frame 540 is sent. The transmitting device 322 thus can only tell directly that the data packet 535 went through. It determines that the data packet 535 did not go through if a certain period of time passes without receiving an ACK frame 540.

The transmitting device 322 then proceeds in one of two different ways depending upon whether it received an ACK frame 540 or not. If the transmitting device 322 received an ACK frame 540, it knows that the data packet 535 was transmitted at an acceptable power level and an acceptable data transmission rate. Therefore, the transmitting device retains its original transmission power and data transmission rate, moves on to the next data packet 535, and proceeds to the next action. (Step 740) This next action may be the transmission of the next data packet 535 if there is sufficient time remaining in the current guaranteed time slot 530, or may involve shutting down until either the next superframe 505 is transmitted or the next guaranteed time slot 530 assigned to the transmitting device 322.

If, however, no ACK frame 540 is received, the transmitting device 322 has no confirmation that the current data packet 535 was successfully transmitted and so must resend it. In this case the transmitting device 322 keeps the current data packet 535, may adjust transmission power and data transmission rate to increase signal quality, and proceeds to the next action. (Step 750) This next action may be the retransmission of the current data packet 535 if there is sufficient time remaining in the current guaranteed time slot 530, or may involve shutting down until either the next superframe 505 is transmitted or the next guaranteed time slot 530 assigned to the transmitting device 322, and then retransmitting the current data packet 535.

In this embodiment, if the transmitting device 322 receives an ACK frame 540, it knows only that the data transmission rate and the transmission power are sufficient, but has no knowledge as to whether it is of better quality than it needs to be. It has no metric to determine whether the data transmission rate could be increased or the transmission power decreased and the data packet 535 still transmit successfully.

One thing the transmitting device 322 can do to achieve an optimal transmission power or data transmission rate is to increment the transmission rate up and/or the transmission power down until it does not receive an ACK frame 540 from the receiving device 324. At this point the transmitting device 322 will know that it is transmitting at the lowest transmission power and the fastest transmission rate that will still allow the data packet 535 to be successfully transmitted. Random errors will of course occur, however, so this is not completely deterministic.

However, using the presence or absence of an ACK frame 540 as the sole determination of an acceptable signal offers very coarse-grained feedback. This can cause an unnecessary loss of data transmission speed as the transmitting device 322 transmits at a lower transmission speed that is optimal, or increased power consumption as the transmitting device 322 transmits at a higher signal quality than is optimal. And while these numbers can be changed, it can only be done slowly.

In an alternate embodiment, the management entity 440 in the receiving device 324 may collect signal clarity information such as the bit error rate (BER), the signal-to-noise ratio (SNR), the received signal strength indication (RSSI) of the transmitted data packets 535, or other signal quality metrics. The receiving device 324 could then transmit this signal clarity information back to the transmitting device 322, where the management entity 440 in the transmitting device 322 could process the signal clarity information to adjust the data transmission speed or transmission power.

Alternatively, the device could send suggested rate and power level changes, if the number of feedback bits were sufficient to pass that information.

But using such metrics as BER, SNR, or RSSI will necessitate slow feedback as the necessary metric must be calculated by the receiving device 324, transmitted from the receiving device 324 to the transmitting device 322 in a separate, longer packet, and then processed by the transmitting device to adjust signal strength and data transmission rate. In addition, metrics must be standardized throughout all devices that might be connected to the network. And for such metrics as SNR and RSSI, this could be hard, leading to complications in implementation.

In another alternate embodiment, feedback information is put into the immediate ACK frames 540. In a preferred embodiment described below, two-bit feedback is used, although other numbers of feedback bits could be used to allow for greater or lesser granularity of feedback.

As shown in Table 1, an embodiment having two feedback bits allows for four separate feedback responses regarding signal quality. In addition, regardless of how many feedback bits are used, if the transmission device receives the ACK frame 540, then the signal is at a transmission strength and data transmission speed that are sufficient to get the transmission through in a satisfactory manner. If it were not, then the transmission device 322 would not have received the ACK frame 540, and would know to increase the transmission power or decrease data transmission speed accordingly.

In the feedback bits, if both are “0” (i.e., a feedback response of “0”), the receiving device 324 indicates that the signal quality is poor and that the transmitting device 322 should either increase transmission power or decrease data transmission speed. If the first feedback bit is “0” and the second feedback bit is “1” (i.e., a feedback response of “1”), the receiving device 324 indicates that the signal quality is within acceptable parameters and that the transmitting device 322 should not change either the transmission power or the data transmission speed. If the first feedback bit is “1” and the second feedback bit is “0” (i.e., a feedback response of “2”), the receiving device indicates that the SNR is higher than is necessary and that the transmitting device 322 should either decrease transmission power or increase data transmission speed. Finally, if the feedback bits are both “1” (i.e., a feedback response of “3”), the receiving device 324 indicates that no signal quality feedback is provided.

TABLE 1
ACK-based Signal Quality Feedback

| Feedback | Feedback | |
|---|---|---|
| Bits | Response | Quality of Signal |
| 00 | 0 | Signal quality is poor. |
| 01 | 1 | Signal quality is within acceptable parameters. |
| 10 | 2 | Signal quality is stronger than necessary. |
| 11 | 3 | No signal quality feedback provided. |

In the preferred embodiment the receiving device 324 evaluates the signal quality based on SNR. However, other embodiments can evaluate signal quality based on other criteria such as BER, RSSI, or whatever metric is desired.

Regardless of the criteria used, this design provides a useful metric that does not specify how the signal quality is evaluated. Rather, it merely indicates to the transmitting device 322 whether the data transmission is so weak that that transmitting device 322 should enhance signal quality, whether the data transmission is adequate so that that transmitting device 322 should leave signal quality the same, or whether the data transmission is so strong that that transmitting device 322 can afford to cut back on signal quality.

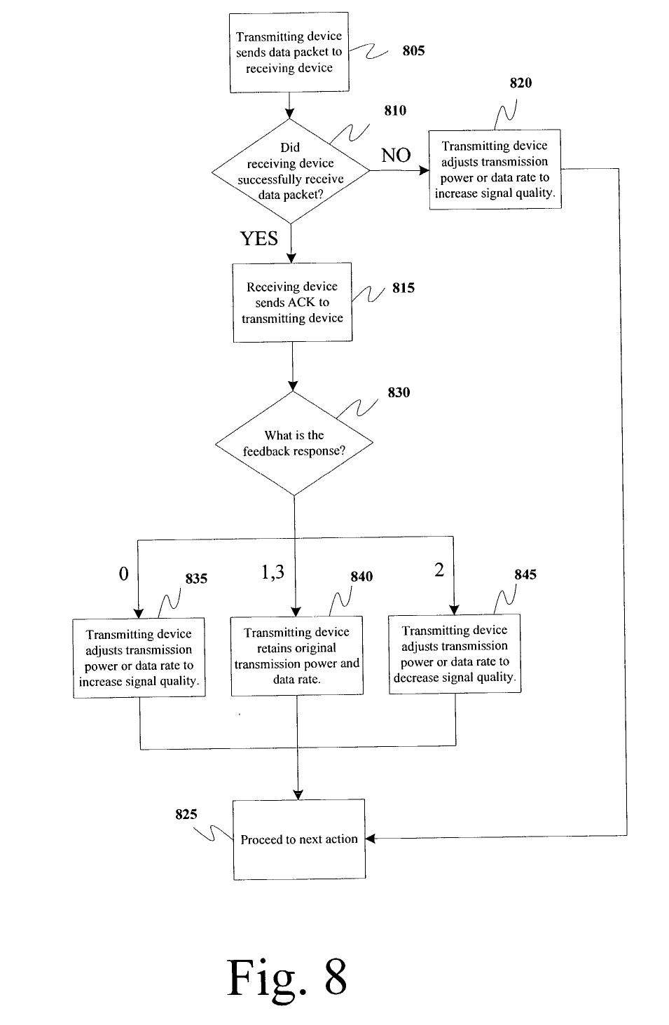

FIG. 8 is a flow chart of the transmission of a data packet 535 and an ACK frame 540 according to another preferred embodiment of the present invention. As shown in FIG. 8, the transmitting device 322 begins by transmitting a data packet 535 to the receiving device 324. (Step 805) This transmission is done over a secondary wireless link 340, unless one of the two devices is also the controller, in which case it may be done over a primary wireless link 330.

Then, the receiving device 324 determines whether it properly received the data packet 535. (Step 810) If the receiving device 324 properly received the data packet 535, it sends an ACK frame 540 to the transmitting device 322. (Step 815 If the receiving device 324 did not properly receive the data packet 535, no ACK frame 540 is sent. This provides the first indication of signal quality to the transmitting device 322, i.e., if the transmitting device 322 receives an ACK, the signal quality was at least at a bare minimum, while if a certain period of time passes without receiving an ACK frame 540, the signal quality was not adequate.

The transmitting device 322 then proceeds in one of two different ways depending upon whether it received an ACK frame 540 or not. If no ACK frame 540 was received, the transmitting device 322 has no confirmation that the current data packet 535 was successfully transmitted and so must resend it. In this case the transmitting device 322 keeps the current data packet 535, may adjust transmission power and data transmission rate to increase signal quality (Step 820), and proceeds to the next action. (Step 825) This next action may be the retransmission of the current data packet 535 if there is sufficient time remaining in the current guaranteed time slot 530, or may involve shutting down until either the next superframe 505 is transmitted or the next guaranteed time slot 530 assigned to the transmitting device 322, and then retransmitting the current data packet 535.

If, however, the transmitting device 322 received an ACK frame 540, it knows that the data packet 535 was transmitted at an acceptable power level and an acceptable data transmission rate. It then looks at the feedback bits (i.e., the feedback response) to see if the transmission power or data transmission rate should be altered. (Step 830)

If the feedback response is “0,” then the transmitted signal was poor and so the transmitting device adjusts the transmission power or the data transmission rate to increase signal quality. (Step 835) This may be the same sort of adjustment made when no ACK frame 540 is received, or it may be a more modest change.

If the feedback response is “1,”then the signal is within acceptable parameters and so the transmitting device 322 retains the original transmission power and data transmission rate. (Step 840)

If the feedback response is “2,” then the signal is stronger than it needs to be and so the transmitting device adjusts the transmission power or the data transmission rate to use fewer resources while providing adequate signal quality. (Step 845)

If the feedback response is “3,” then the no data is transmitted with respect to the signal quality. However, because the transmitting device 322 received an ACK frame 540, the data packet 535 was at least readable, the transmitting device 322 can retain the original transmission power and data transmission rate. (Step 840).

Alternatively if the feedback response were “3,” the transmitting device could engage in trial and error rate/power changes in the absence of additional feedback data.

Finally, once the transmitting device 322 has made what changes to transmission power or data transmission rate are necessary, if any, the network 300 proceeds to the next action. This next action may be the transmission of the next data packet 535 if there is sufficient time remaining in the current guaranteed time slot 530, or may involve shutting down until either the next superframe 505 is transmitted or the next guaranteed time slot 530 assigned to the transmitting device 322.

The specific metrics and thresholds in this embodiment can be left up to individual implementations, allowing for tremendous flexibility of design. Because the same feedback bits are used regardless of how stringent the data transmission criteria are, no changes need be made for more stringent data transmission standards. In those implementations where the need for consistently high data transmission rates and/or low power consumption is not paramount, high thresholds can be set for when the feedback bits will indicate that the signal quality is too high. Likewise In those implementations where the concern for battery power or transmission speed is highest, lower thresholds can be set for when the feedback bits will indicate that the signal quality is too high.

Furthermore, this design does not require a standardization of SNR or RSSI, nor does it mandate an estimation of BER. By leaving it up to the receiving device 324 to determine when the signal quality is higher than needed or too low, this design allows the receiving device 324 to make a decision based on its own criteria.

In fact, the criteria for individual receiving devices 324 may not even be the same, but can vary device to device. For example, in a home network with a PDA, computer, a DVD player, and some digital speakers connected, there may be an entirely different set of criteria for the speakers as compared to the PDA. Because both the DVD and the speakers are plugged into wall sockets, power considerations may be less than the need to minimize missed data packets (and thus skips in the music). Likewise the need for high-speed low error rate transmissions may be great for the speakers to ensure clean sound quality. This may lead to a high threshold before the network will cut back on data transmission speed or power consumption. In contrast, your PDA has a limited power supply, so minimizing power consumption is a high priority and packet errors are more easily tolerated for data transmission. It may have a low threshold for cutting back, accepting a lower quality of service to maximize battery power.

In addition, each transmission device 322 can decide independently what to do with the feedback. It can increase or decrease signal transmitter power, if possible, or it can increase or decrease burst transmission rate to increase or reduce the energy per bit over the noise spectral density (Eb/No) as appropriate.

While this application specifically refers to a transmission device and a receiving device, it is understood that both may be operating in each capacity. Thus, each device in the network will at times be both a transmitting device and a receiving device, and will either generate or receive feedback bits. Likewise, the controller may function as a device as well, receiving and generating feedback bits and adjusting its signal quality.

This application refers throughout to altering the transmission power and the data transmission rate to either raise or lower the signal quality. How exactly this is done may vary, yet stay within the scope of the preferred embodiments of the present invention. Specific implementations will vary depending upon system or device criteria. For example, the signal quality can be raised by either lowering data transmission speed or raising transmission power. Likewise, the signal quality can be lowered by either raising data transmission speed or lowering transmission power.

As noted, in alternate embodiments a greater or lesser number of bits could be used as feedback bits. If only one bit were used, it might indicate whether the signal quality could be cut back or not. If three or more bits were used, they might indicate to what extent signal quality must be enhanced or could be cut back, with several levels of transmission power/data transmission speed adjustments. Alternatively, the feedback bits could provide other information such as a suggested data transmission rate or a suggested change in power.

In addition, although an embodiment has been disclosed that uses immediate acknowledgement (ACK) frames, alternate embodiments could use delayed ACK frames. In this case the transmitting device would send a plurality of data packets before the receiving device sent a delayed ACK frame. This delayed ACK frame would provide acknowledgement information for the plurality of data packets, and could include feedback bits to provide the transmitter with information regarding signal quality.

Obviously, numerous modifications and variations of the present invention are possible in light of the above teachings. It is therefore to be understood that within the scope of the appended claims, the invention may be practiced otherwise than as specifically described herein.

What is claimed is:

1. A method for providing signal quality feedback in a wireless network, including the steps of:
sending a data packet from a transmitting device to a receiving device in a wireless data signal sent over a wireless link at a first transmission power and a first data transmission rate;
receiving the data packet in the wireless data signal at a receiving device;
determining at the receiving device a signal quality metric for the wireless data signal;
sending an acknowledgement frame from the receiving device to the transmitting device in a wireless acknowledgement signal, the acknowledgement frame including one or more feedback bits indicating a relative signal quality of the wireless data signal;
receiving the acknowledgement frame in the wireless acknowledgement signal at the transmitting device; and
adjusting the first transmission power and the first data transmission rate to a second transmission power and a second data transmission rate, respectively, based on the one or more feedback bits.

2. A method for providing signal quality feedback in a wireless network, as recited in claim 1, wherein the signal quality metric is one of signal-to-noise ratio, bit error rate, or a received signal strength indication.

3. A method for providing signal quality feedback in a wireless network, as recited in claim 1, wherein the acknowledgement frame is an immediate acknowledgement frame.

4. A method for providing signal quality feedback in a wireless network, as recited in claim 1, wherein a first value of the one or more feedback bits indicates that the wireless data signal has a signal quality metric that is above an optimal range.

5. A method for providing signal quality feedback in a wireless network, as recited in claim 4, wherein when the feedback bits have the first value, either the second transmission power is lower than the first transmission power, or the second data transmission rate is higher than the first data transmission rate.

6. A method for providing signal quality feedback in a wireless network, as recited in claim 1, wherein there are two feedback bits.

7. A method for providing signal quality feedback in a wireless network, as recited in claim 6,
wherein a first combination of the two feedback bits indicates that the wireless data signal has a signal quality metric that is above an optimal range,
wherein a second combination of the two feedback bits indicates that the wireless data signal has a signal quality metric that is within an optimal range,
wherein a third combination of the two feedback bits indicates that the wireless data signal has a signal quality metric that is below an optimal range, and
wherein a fourth combination of the two feedback bits indicates that no signal quality information has been provided.

8. A method for providing signal quality feedback in a wireless network, as recited in claim 1, wherein the one or more feedback bits indicate whether the signal quality metric of the wireless data signal is within an optimal range, above an optimal range, or below an optimal range.

9. A method for providing signal quality feedback in a wireless network, as recited in claim 1, wherein adjusting the first transmission power and the first data transmission rate to a second transmission power and a second data transmission rate, respectively, can comprise having the second transmission power equal the first transmission power and having the second data transmission rate equal the first data transmission rate.
